(19) United States
(12) Patent Application Publication
(10) Pub. No.: US 2013/0027344 A1
(43) Pub. Date: Jan. 31, 2013

(54) Apparatus Including a Touch-Sensitive Interface Including a Serpentine Electrode Pattern

(71) Applicant: Sim Kok Choon, Singapore (SG)

(72) Inventor: Sim Kok Choon, Singapore (SG)

(21) Appl. No.: 13/194,738

(22) Filed: Jul. 29, 2011

(51) Int. Cl. G06F 3/044; H02J 4/00

(52) U.S. Cl. 345/174; 307/109

(57) ABSTRACT

An apparatus includes a capacitive array formed from a plurality of electrodes including a first plurality of electrodes and a second plurality of electrodes. At least some of the first plurality of electrodes has a serpentine shape and extends in a first direction. The second plurality of electrodes extends in a second direction that is substantially perpendicular to the first direction. The apparatus further includes a capacitive sensor circuit coupled to the capacitive array and configured to detect an object relative to the capacitive array based on a change in a capacitance determined from at least one of the first plurality of electrodes.

### FIELD

The present disclosure is generally related to capacitive touchscreens, and more particularly to a touchscreen electrode configuration.

### BACKGROUND

Touch-sensitive circuits are often utilized as input interfaces for small electronic devices, such as mobile telephones and personal digital assistants (PDAs), as well as tablet computers. Further, such touch-sensitive circuits can be used in track pads and other contact-based user inputs. Touch-sensitive circuits include circuitry configured to detect contact, such as contact by a finger or stylus, within an active area of a contact surface, or a display area of a touchscreen display. Various technologies can be used to sense touch from a finger or stylus, including resistive sensors, capacitive sensors, infrared sensors, and acoustic sensors. Resistive sensors detect contact with an associated surface based on a change in resistance with respect to one or more electrodes, while capacitive sensors detect contact with the associated surface based on a change in capacitance between one or more pairs of electrodes Infrared and acoustic detection circuits detect contact with the associated surface by detecting interruptions in infrared or acoustic waves traveling across the surface.

### SUMMARY

In an embodiment, an apparatus includes a capacitive array formed from a plurality of electrodes, where at least some of the plurality of electrodes has a serpentine shape. The apparatus further includes a capacitive sensor circuit coupled to the capacitive array and configured to detect an object relative to the capacitive array based on a change in a capacitance.

In another embodiment, an apparatus includes a capacitive array configurable to couple to a touchscreen panel. The capacitive array includes a plurality of electrodes. At least some of the plurality of electrodes has a serpentine pattern. The apparatus further includes an integrated circuit coupled to the capacitive array. The integrated circuit is configured to detect proximity of an object to a surface of the touchscreen panel based on a change in capacitance on at least one of the plurality of electrodes.

In still another embodiment, an apparatus includes a substrate, and a plurality of electrodes formed on the substrate and separated from one another by a dielectric. The plurality of electrodes includes a plurality of transmit electrodes extending in a first direction and a plurality of receive electrodes extending in a second direction. Each of the plurality of receive electrodes has a serpentine pattern. The apparatus further includes a plurality of terminals configurable to provide an object's position relative to the substrate.

### BRIEF DESCRIPTION OF THE DRAWINGS

FIG. 1 is a block diagram of an embodiment of a system including a touchscreen having a touch-sensitive array of capacitive electrodes and an integrated circuit coupled to the touchscreen.

FIG. 2 is an expanded view of one of the receive electrodes of the touch-sensitive array of FIG. 1.

FIG. 3 is a partial cross-sectional view taken along line 3-3 in FIG. 1 and partial block diagram of an illustrative example of a portion of the integrated circuit of FIG. 1 including a transmitter electrode and a receiver electrode of a pair of the capacitive electrodes.

FIG. 4 is a block diagram of a portion of the integrated circuit of FIG. 1 including an expanded view of a portion of the sensor circuit.

FIG. 5 is a block diagram of a portion of a substrate depicting a serpentine pattern of the transmitter electrodes relative to the receiver electrode of the touch-sensitive array of FIG. 1.

In the following discussion, the same reference numerals are reused within the figures to indicate the same or similar elements.

### DETAILED DESCRIPTION OF ILLUSTRATIVE EMBODIMENTS

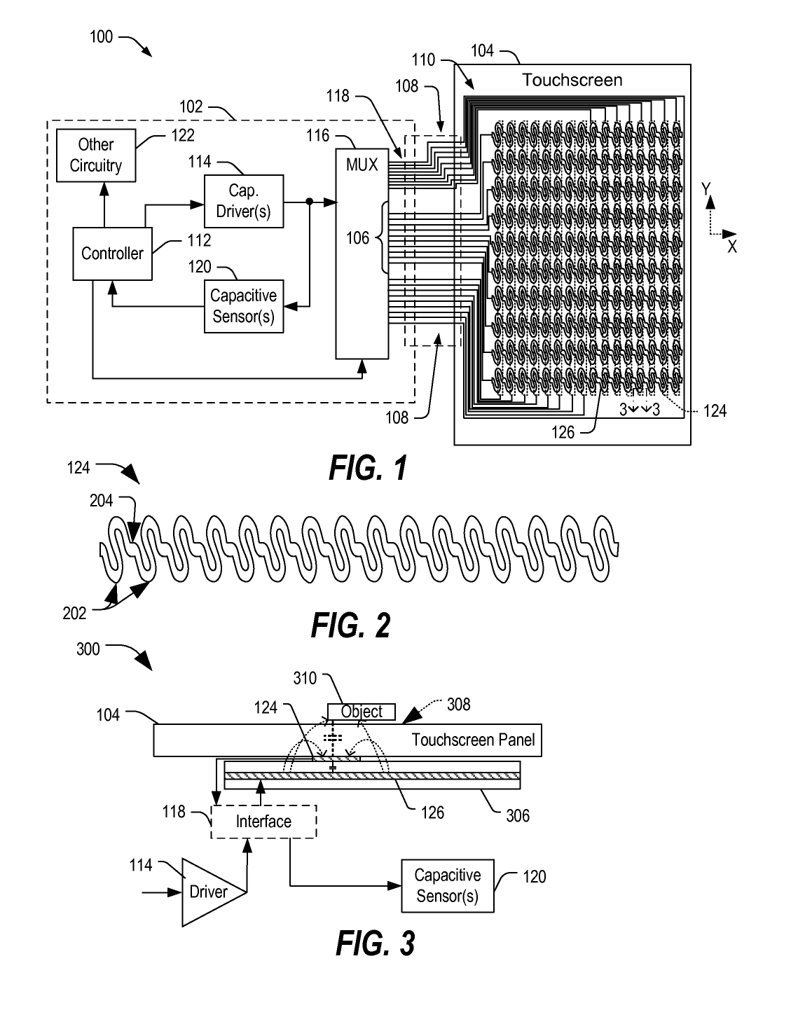

Embodiments of an apparatus and methods are described below for providing touch-sensitive capabilities using pairs of electrodes having serpentine shapes or patterns. In an example, a touch sensor is formed from two electrodes: a transmitter electrode and a receiver electrode having a serpentine shape. In response to contact (or in some instances proximity) of an object, charge transfers from the transmitter electrode to the receiver electrode. Regardless of whether the electrodes are in the same or different layers and regardless of whether the electrodes are in parallel over overlap, the charges transfer intensively along the edge between the transmitter electrode and the receiver electrode instead of across the entire surface area of both electrodes. The serpentine pattern of the receive electrodes extends the edge between the electrodes to facilitate the charge transfer while reducing or eliminating sharp corners or edges, which can tend to store or capture charges instead of transferring them to the receiver electrode, thereby enhancing noise suppression. An example of one possible embodiment of a system including a touchscreen having a capacitive array formed from electrodes with serpentine shapes is described below with respect to FIG. 1.

FIG. 1 is a block diagram of an embodiment of a system 100 including a touchscreen 104 having a touch-sensitive array and an integrated circuit 102 coupled to the touchscreen 104. Integrated circuit 102 is coupled to touchscreen 104 through an interface 118 via receive wires 108 coupled to receive electrodes 124 of touch-sensitive array 110 and transmit wires 106 coupled to transmit electrodes 126 of touch-sensitive array 110. Integrated circuit 102 includes a controller 112 having a first output coupled to a capacitive driver circuit 114, which has an output coupled to an input of multiplexer (MUX) 116. MUX 116 includes a plurality of outputs coupled to a plurality of pads or pins of interface 118, which is coupled to the capacitive electrodes 110 of touchscreen 104.

Controller 112 further includes a control output coupled to a select input of multiplexer 116 and a capacitive sensor input coupled to an output of a capacitive sensor circuit 120, which has an input coupled to the output of capacitive driver circuit 114. Controller 112 is further coupled to other circuit 122, such as a host interface, a processor, a memory, other circuits, or any combination thereof.

Capacitive array 110 includes transmit electrodes 126 extending substantially in an X-direction as indicated by the X-Y axis. Further, touch-sensitive array 110 includes receive electrodes 124 extending substantially in a Y-direction. A dielectric material (not shown) separates the transmit electrodes 126 from the receive electrodes 124 to form capacitive elements at each intersecting (overlapping) location. A change in capacitance at any such location can be detected to determine proximity and/or contact by an object based on signals provided to controller 112 by capacitive sensor circuit 120.

In an example, transmit electrodes 126 extend in a first direction, and receive electrodes 124 extend in a second direction that is substantially perpendicular or orthogonal to the first direction. As used herein, the term “substantially perpendicular” or “substantially orthogonal” refers to a general longitudinal direction of the respective electrodes. For example, if both the transmit and receive electrodes were formed of straight wire traces, the term “substantially” is included to recognize that the electrodes may not be precisely perpendicular and so are perpendicular to one another within fabrication and design tolerances. However, if one or both of the electrodes have non-linear shaped components, such as a curved or serpentine shape, the electrodes generally extend perpendicular to one another, but at any selected point on a curved portion of one of the electrodes, the direction may not be perpendicular at that point. Accordingly, in such an instance, the term “substantially” is meant to refer to the general direction in which the the non-linear electrode extends.

In an example, controller 112 controls driver circuit 114 and MUX 116 to automatically scan a sequence of transmit electrodes 126 and to detect changes in capacitance on receive electrodes 124, which changes can indicate proximity of or contact by an object, such as a finger, a stylus, or other object relative to a contact surface of touchscreen 104. Alternatively, capacitive sense circuit 120 continuously monitors the capacitances between drive electrodes (such as drive electrode 126) and receive electrodes (such as receive electrode 124), and a change in the mutual capacitance between electrodes indicates the presence and position of an object. In this example, capacitive sensor 120 can measure the capacitance of one or more electrodes 110.

Transmit electrodes 126 have a serpentine configuration or pattern, providing more edge area for formation of electrical fields that can be interrupted by an object to be detected. The greater edge area afforded by the serpentine pattern provides enhanced field strength. Capacitive sensor 120 detects the presence or contact of an object with the touchscreen 104 based on disruptions to the electrical fields. The serpentine pattern of transmit electrodes 126 provide enhanced field strength, which provides enhanced charge transfer between the transmit electrodes 126 and the receive electrodes 124 and provides improved noise suppression by reducing undesired storage of stray charge. An expanded view of one possible example of a transmit electrode having a serpentine shape is described below with respect to FIG. 2.

FIG. 2 is an expanded view of one of the transmit electrodes 126 of the touch-sensitive array 110 of FIG. 1. Transmit electrode 126 has a serpentine pattern that includes S-shaped (curved) portions 202 and bridge portions 204 that link adjacent S-shaped portions. As used herein, the term “serpentine pattern” refers to an electrode shape that includes a plurality of curved portions. However, along its length, the electrode may include straight portions as well. Other configurations can also be used to expand the edge area of the transmit electrode 126, provided that bends are curved and without sharp corners, which tend to store charge and introduce stray noise.

In an example, capacitive electrode 126 may be formed in a first layer of a substrate and receive electrode 124 may be formed in a second layer of the substrate. An example of a cross-sectional view of an apparatus including the touchscreen panel 104 and electrodes 110 is described below with respect to FIG. 2.

FIG. 3 is a partial cross-sectional view taken along line 3-3 in FIG. 1 and partial block diagram 300 of an illustrative example of a portion of the integrated circuit 102 of FIG. 1 including transmit electrode 126 and receive electrode 124 of the capacitive array 110. Transmit electrode 126 and receiver electrode 124 are formed on different layers of a substrate 301. In the illustrated example, transmit electrode 126 and receive electrode 124 are formed on different layers of a substrate 306. However, in some instances, transmit and receive electrodes 126 and 124 may be formed on a common layer of the substrate 306 and bridge portions or vias may be used to maintain separation between transmit electrode 126 and receive electrode 124 where they overlap. In such an instance, receive electrodes 124 may be shifted to extend parallel to the curved or S-shaped portions 202 and to overlap with the bridge portions 204.

Diagram 300 includes driver circuit 114 having an input for receiving a signal and an output for providing a drive signal to transmit electrode 126 through interface 118. Application of the drive signal to transmit electrode 126 causes formation of electrical field lines (generally indicated at 308), which extend from transmit electrode 126 into and through the touchscreen panel 104 and through substrate 306 terminating on receive electrode 124. Some of the electrical field lines may terminated in another nearby electrode (not shown) or may not terminate. Receive electrode 124 is coupled to an input of capacitive sensor circuit 120.

In an example, when an object, such as object 310, which may be a finger, a stylus, or some other object, nears or contacts the surface of touchscreen panel 104, the object 310 causes the electrical field lines 308 to deform and to terminate at the object 310, changing a capacitance between transmit electrode 126 and receive electrode 124, which change is detectable by capacitive sensor circuit 120.

Receiver electrode 124 is separated from transmitter electrode 126 by a dielectric. In this example, charges transfer intensively along the edge between the transmitter electrodes 126 and receiver electrode 124, instead of across the surface area of both electrodes. Stray charges also transfer, thereby suppressing noise.

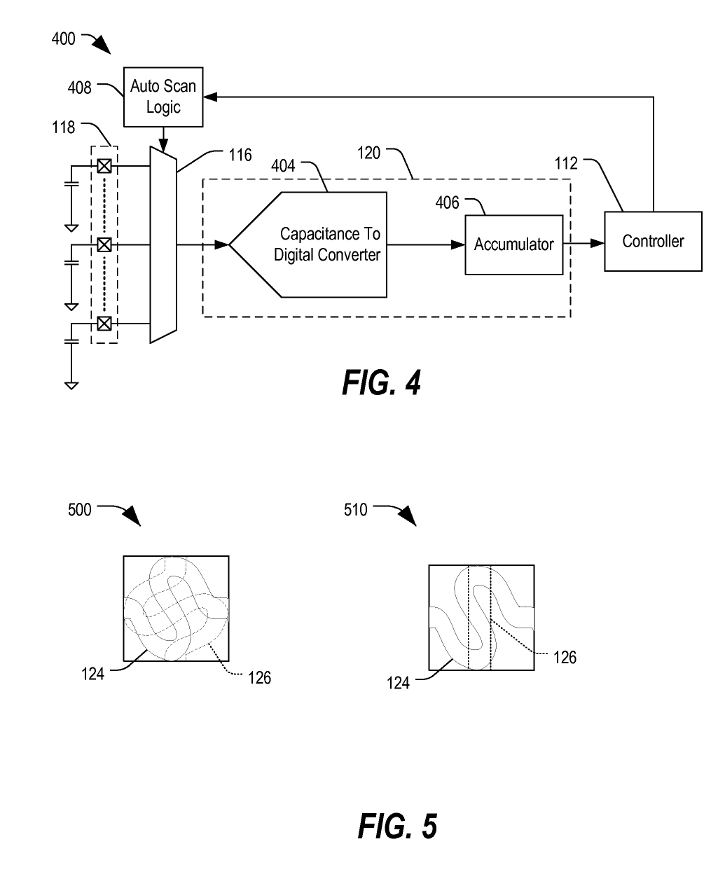

FIG. 4 is a block diagram 400 of a portion of the integrated circuit 102 of FIG. 1 including an expanded view of a portion of the capacitive sensor circuit 120. In this example, interface 118 includes a plurality of pins or pads, which couple to the touch-sensitive array 110 of touchscreen panel 104, as indicated by the discrete capacitors. Interface 118 includes a plurality of outputs, which are coupled to a respective plurality of inputs of MUX 116, which has a select input coupled to an output of an auto scan logic circuit 408, and an output coupled to an input of capacitive sensor circuit 120. Capacitive sensor circuit 120 further includes an output coupled to an input of controller 112, which has an output coupled to auto scan logic circuit 408. Capacitive sensor circuit 120 includes a capacitance to digital converter 404 including an input coupled to the output of MUX 116 and an output coupled to an input of an accumulator 406. Accumulator 406 has an output coupled to an input of controller 112. Accumulator 406 may be configured to average multiple values at the output of the capacitance to digital converter 404 for a selected input channel or group of input channels.

In the illustrated example, controller 112 controls auto scan logic 406 to select one or more pins or pads of interface 118 to couple the selected one or more pins or pads to the input of capacitance to digital converter 404 via multiplexer 116. Capacitance to digital converter 404 converts the capacitance to a digital sample and provides the digital sample to accumulator 406 for aggregating the value. Conversions can be configured to convert a single channel continuously or can automatically convert a group of channels sequentially. The accumulator 406 provides the value to controller 112, which is configured to detect a location of the object relative to the touchscreen panel 104 and to adjust the auto scan logic 408 to sample one or more other pins or pads of interface 118.

In an example, controller 112 may compare the output of capacitance to digital converter 404 to a threshold. For example, if the apparatus is in a low-power operating mode, a change in capacitance that exceeds the threshold can be used by controller 112 to detect a comparator event and to generate a wakeup signal in response to detecting the comparator event. In an example, controller 112 may remain in a low-power mode until a sampled value of one of the scanned channels exceeds the threshold.

FIG. 5 is a block diagram of a portion of substrates 500 and 510 depicting a serpentine pattern of the transmitter electrode 126 and relative to receiver electrode 124 of the touch-sensitive array 110 of FIG. 1. In this example, receive electrode 124 is formed on a different layer of the substrates 500 and 510 relative to transmit electrode 126. Accordingly, receive electrode 124 is depicted in phantom.

Substrate 500 supports transmit electrode 126 having a serpentine pattern and receive electrode 124 having a serpentine pattern as well. In the configuration of substrate 510, transmit electrode 126 has a serpentine pattern, and receive electrode 124 forms a substantially straight line. Other patterns and other configurations of the receive electrode 124 relative to the transmit electrode 126 are also possible. For example, receive electrode 124 may be offset to one side or the other of the visible portions depicted in FIG. 5. In another example, receive electrode 124 may have the same or a different pattern relative to transmit electrode 126.

In conjunction with the circuits and apparatus described above with respect FIGS. 1-5, a touch-sensitive circuit is disclosed that includes at least two electrodes: a transmit electrode and a receive electrode. The electrodes are formed on a substrate and the transmit electrode has a serpentine pattern. An integrated circuit is coupled to the electrodes to detect proximity (or contact) of an object with a surface of a touchscreen based on a change in capacitance. Regardless of whether the electrodes are formed in a common layer or in different layers (and/or overlap), charges transfer along edges between the electrodes and with improved sensitivity and reduced noise.

Although the present invention has been described with reference to preferred embodiments, workers skilled in the art will recognize that changes may be made in form and detail without departing from the scope of the invention.

What is claimed is:

1. An apparatus comprising:
a capacitive array formed from a plurality of electrodes, the capacitive array comprising a first plurality of electrodes and a second plurality of electrodes, at least some of the first plurality of electrodes having a serpentine shape and extending in a first direction, the second plurality of electrodes extending in a second direction that is substantially perpendicular to the first direction; and
a capacitive sensor circuit coupled to the capacitive array and configured to detect an object relative to the capacitive array based on a change in a capacitance determined from at least one of the first plurality of electrodes.

2. The apparatus of claim 1, wherein each of the first plurality of electrodes has a plurality of curved portions coupled to each other by a respective plurality of bridge portions.

3. The apparatus of claim 1, wherein:
the plurality of electrodes are formed on a substrate including multiple layers;
the first plurality of electrodes are formed in a first layer of the multiple layers; and
the second plurality of electrodes are formed in a second layer of the multiple layers.

4. The apparatus of claim 1, wherein the second plurality of electrodes have a serpentine pattern.

5. The apparatus of claim 1, wherein the first and second pluralities of electrodes are formed in a common layer of the substrate.

6. The apparatus of claim 1, further comprising:
a multiplexer including a first terminal, a control terminal, and a plurality of second terminals coupled to the first plurality of electrodes;
a driver circuit coupled to the first terminal of the multiplexer and configured to provide a drive signal to the first terminal of the multiplexer; and
a controller coupled to the control terminal of the multiplexer to selectively couple the driver circuit to one or more of the plurality of transmit electrodes.

7. The apparatus of claim 6, wherein the plurality of electrodes is configured to intensively transfer charges between edges of adjacent ones of the plurality of electrodes.

8. An apparatus comprising:
a capacitive array configurable to couple to a touchscreen panel, the capacitive array including a plurality of electrodes, at least some of the plurality of electrodes having a serpentine pattern; and
an integrated circuit coupled to the capacitive array, the integrated circuit configured to detect proximity of an object to a surface of the touchscreen panel based on a change in capacitance on at least one of the plurality of electrodes.

9. The apparatus of claim 8, wherein the plurality of electrodes are formed on a common layer of a substrate.

10. The apparatus of claim 8, wherein the plurality of electrodes include:
a plurality of transmit electrodes formed in a first layer of a substrate; and
a plurality of receive electrodes formed in a second layer of the substrate.

11. The apparatus of claim 10, wherein the plurality of receive electrodes have a serpentine pattern.

12. The apparatus of claim 10, wherein the plurality of transmit electrodes are substantially orthogonal to the plurality of receive electrodes.

13. The apparatus of claim 12, wherein each of the plurality of transmit electrodes and each of the plurality of receive electrodes has a serpentine pattern.

14. The apparatus of claim 8, wherein the integrated circuit comprises:
a multiplexer including an input, a select input, and a plurality of outputs coupled to the plurality of electrodes;
a driver circuit coupled to the input of the multiplexer and configured to apply a signal to one or more of the plurality of electrodes;
a capacitive sensor circuit including an input coupled to the input of the multiplexer and configured to sense a capacitance of one or more of the plurality of electrodes and including an output; and
a controller including a control output coupled to the select input of the multiplexer and an input coupled to the output of the capacitive sensor circuit, the controller configured to apply control signals to the select input to control operation of the multiplexer.

15. The apparatus of claim 14, wherein the capacitive sensor circuit comprises:
a capacitance to digital converter circuit including an input coupled to the input of the multiplexer and an output; and
an accumulator including an input coupled to the output of the capacitance to digital converter circuit and an output coupled to the input of the controller, the accumulator configured to average multiple samples of measurements taken from a selected one of the plurality of electrodes.

16. An apparatus comprising:
a substrate;
a plurality of electrodes formed on the substrate and separated from one another by a dielectric, the plurality of electrodes including a plurality of transmit electrodes extending in a first direction and a plurality of receive electrodes extending in a second direction, at least some of the plurality of receive electrodes having a serpentine pattern; and
a plurality of terminals configurable to provide an object's position relative to the substrate.

17. The apparatus of claim 16, further comprising an integrated circuit coupled to the plurality of electrodes via the plurality of terminals, the integrated circuit including a controller configured to detect a proximity of an object relative to the substrate based on a change in capacitance between adjacent ones of the plurality of electrodes.

18. The apparatus of claim 17, wherein the integrated circuit further comprises:
a multiplexer including a plurality of outputs coupled to the plurality of terminals through the interface, the multiplexer including a control input and a data input;
a driver including an input for receiving a signal and an output coupled to the data input;
a sensor circuit including an input coupled to the output of the driver and an output coupled to an input of the controller; and
wherein the controller controls operation of the multiplexer and the driver to scan a capacitance of the plurality of electrodes.

19. The apparatus of claim 16, wherein the plurality of transmit electrodes are formed in a different layer of the substrate relative to the plurality of receive electrodes.

20. That apparatus of claim 16, wherein the plurality of transmit electrodes extend orthogonal to the plurality of receive electrodes.
